(19) United States
(12) Patent Application Publication
(10) Pub. No.: US 2011/0221725 A1
(43) Pub. Date: Sep. 15, 2011

(54) TWO-DIMENSIONAL SENSOR ARRAY, DISPLAY DEVICE, AND ELECTRONICS DEVICE

(76) Inventors: Atsuhito Murai, Osaka (JP); Hajime Imai, Osaka (JP); Hideki Kitagawa, Osaka (JP)

(21) Appl. No.: 13/130,114

(22) PCT Filed: Jul. 30, 2009
(86) PCT No.: PCT/JP2009/063604

§ 371 Date: May 19, 2011

(30) Foreign Application Priority Data
Nov. 21, 2008 (JP) 2008-298687

(51) Int. Cl. G09G 5/00; G01J 1/44

(52) U.S. Cl. 345/207; 250/208.2

(57) ABSTRACT

A display device according to the present invention includes: a plurality of pixels arranged in matrix; photoelectric elements being provided in each of the pixels and each outputting a signal with a value according to the quantity of light received by the photoelectric element, the photoelectric elements forming photoelectric element groups (PDs(n)) in each of which the photoelectric elements arranged along a one-dimensional direction are grouped; and resetting wirings (Vrts(n+1)), each of which is connected to the anode side electrodes of the photoelectric elements in the corresponding one (PDs(n)) of the photoelectric element groups commonly, and is shared by an adjacent one (PDs(n+1)) of the photoelectric element groups. This configuration makes it possible to provide such a display device having a pixel including an optical sensor incorporated therein, that is not affected by the resolution and the performance of an output AMP and is capable of preventing a decrease in the aperture ratio of the pixel.

### TECHNICAL FIELD

The present invention relates to a display device including a display panel in which an optical sensor is incorporated in a pixel.

### BACKGROUND ART

Conventionally, there has been developed a display device including a display panel in which an optical sensor is incorporated in a pixel.

This display panel faces such a problem that, since the display panel needs an optical sensor and a wiring for driving the optical sensor in the pixel, the pixel has a low aperture ratio compared to a case where no optical sensor is incorporated in a pixel.

In view of this, Patent Literature 1, for example, discloses a configuration in which an optical sensor output wiring Vom also serves as a display source wiring Sm . . . , and a wiring Vsm for supplying voltage to an output AMP also serves as a display source wiring Sm . . . as illustrated in FIG. 13. This configuration suppresses a decrease in the aperture ratio of a pixel, the decrease resulting from providing an optical sensor in the pixel.

### CITATION LIST

### Patent Literature 1

International Publication No. WO2007/145347 [Publication Date: Dec. 21, 2007]

### SUMMARY OF INVENTION

### Technical Problem

However, since the display source wiring Sm . . . also serves as the optical sensor output wiring Vom and the display source wiring Sm . . . also serves as the wiring Vsm for supplying voltage to the output AMP in the configuration as shown in FIG. 13, it is impossible to read a sensor circuit during the charging of a picture element (period in which video data is applied to the source wiring) as shown in FIG. 14. Accordingly, the reading of the sensor circuit can be carried out only in a flyback period. This makes it difficult to share the wirings in a case where the flyback period is short, for example, when the resolution of the display is high (VGA, XGA, etc.), or in a case where the output AMP has a low performance (for example, in a case where an AMP transistor is formed from an a-Si).

One possible solution for avoiding such problem is, for example, such that the optical sensor output wiring Vom and the wiring Vsm for supplying voltage to the output AMP are provided in addition to the display source wiring Sm . . . as shown in FIG. 15. However, this increases the number of wirings for driving the optical sensor (optical sensor output wiring Vom, wiring Vsm for supplying voltage to the output AMP). The increase will lead to a low aperture ratio of the pixels compared to a case where no optical sensor is provided.

The present invention is accomplished in view of the aforementioned problems. An object of the present invention is to make a display device having a pixel including an optical sensor incorporated therein, the display device not being affected by the resolution and the performance of an output AMP and being capable of preventing a decrease in the aperture ratio of the pixel.

### Solution to Problem

In order to attain the object, a two-dimensional sensor array according to the present invention is a two-dimensional sensor array including: a plurality of photoelectric elements being two-dimensionally arranged and each outputting a signal with a value according to the quantity of light received by the photoelectric element, the plurality of photoelectric elements forming photoelectric element groups in each of which photoelectric elements arranged along a one-dimensional direction are grouped; and wirings, each of which is connected to the anode electrodes of the photoelectric elements in the corresponding one of the photoelectric element groups commonly, and is shared by at least two of the photoelectric element groups.

According to the configuration above, the wiring which is commonly connected to the anode electrodes of the photoelectric elements in one photoelectric element group is shared by at least two photoelectric element groups. This makes it possible to reduce the number of wirings at least by half compared to a case in which the above-described wiring is not shared by the photoelectric element groups.

The reduction in the number of wirings makes it possible to simplify the circuit configuration of the two-dimensional sensor array.

For example, in a case where this two-dimensional sensor array is used in a display device and the above-described photoelectric element is provided in each pixel, it is possible to reduce the number of wirings at least by half compared to a case where the wiring is not shared by the photoelectric element groups. The reduction makes it possible to avoid a decrease in the aperture ratio of the pixel, the decrease resulting from providing the photoelectric element. That is, as described above, it becomes possible to increase the aperture ratio of the pixel compared to the case in which the wiring connected commonly to the anode electrodes of the photoelectric elements in one photoelectric element group, in which photoelectric elements arranged along a one-dimensional direction are grouped, is not shared.

Further, the plurality of photoelectric elements include photoelectric elements effective for extracting sensing data, wherein it is preferable that the photoelectric elements effective for extracting sensing data be arranged in such a manner that centers of light reception sections of adjacent ones of the photoelectric elements are distanced with a predetermined error range.

According to the configuration above, the plurality of photoelectric elements include photoelectric elements effective for extracting sensing data, wherein the photoelectric elements effective for extracting sensing data are arranged in such a manner that centers of light reception sections of adjacent ones of the photoelectric elements are distanced with a predetermined error range. This configuration makes it possible to suppress deterioration in sensor accuracy in the two-dimensional sensor array.

In order to attain the object, a display device according to the present invention is a display device including: a plurality of pixels arranged in matrix; photoelectric elements each outputting a signal with a value according to the quantity of light received by the photoelectric element, the photoelectric elements forming photoelectric element groups in each of which the photoelectric elements arranged along a one-dimensional direction are grouped; and wirings, each of which is connected to the anode electrodes of the photoelectric elements in the corresponding one of the photoelectric element groups commonly, and is shared by at least two of the photoelectric element groups.

According to the configuration above, the wiring which is commonly connected to the anode electrodes of the photoelectric elements in one photoelectric element group is shared by at least two of the photoelectric element groups. This configuration makes it possible to reduce the number of wirings at least by half compared to a case in which the above-described wiring is not shared by the photoelectric element groups.

Consequently, in a case where the above-described photoelectric element is provided in each pixel, for example, it is possible to reduce the number of wirings at least by half compared to a case where the wiring is not shared by the photoelectric element groups. The reduction makes it possible to avoid a decrease in the aperture ratio of the pixel, the decrease resulting from providing the photoelectric element. That is, as described above, it becomes possible to increase the aperture ratio of the pixel compared to the case in which the wiring connected commonly to the anode electrodes of the photoelectric elements in one photoelectric element group, in which photoelectric elements arranged along a one-dimensional direction are grouped, is not shared.

Further, the plurality of photoelectric elements include photoelectric elements effective for extracting sensing data, wherein it is preferable that the photoelectric elements effective for extracting sensing data be arranged in such a manner that centers of light reception sections of adjacent ones of the photoelectric elements are distanced with a predetermined error range.

According to the configuration above, the plurality of photoelectric elements include photoelectric elements effective for extracting sensing data, wherein the photoelectric elements effective for extracting sensing data are arranged in such a manner that centers of light reception sections of adjacent ones of the photoelectric elements are distanced with a predetermined error range. This configuration makes it possible to suppress deterioration in sensor accuracy in the two-dimensional sensor array included in the display device.

In order to attain the object, a display device according to the present invention is a display device including: a plurality of pixels arranged in matrix; and photoelectric elements being provided in each of the plurality of pixels and each outputting a signal with a value according to the quantity of light received by the photoelectric element, the photoelectric elements being arranged such that: when photoelectric elements being arranged in the n-th row (n is an integer equal to or greater than 1) form a photoelectric element group (PDs(n)), (a) the anode electrodes of the photoelectric elements in a photoelectric element group (PDs(n+1)) adjacent to the photoelectric element group (PDs(n)) and (b) the anode electrodes of the photoelectric elements in the photoelectric element group (PDs(n)) are commonly connected to a common wiring (Vrst(n): (n is an integer equal to or greater than 1)), and the common wiring (Vrst(n)) is formed between an address wiring (G(n): (n is an integer equal to or greater than 1)), which is connected commonly to pixels with which the photoelectric element group (PDs(n)) is associated, and an address wiring (G(n+1)), which is connected commonly to pixels with which the photoelectric element group (PDs(n+1)) is associated.

According to the configuration above, the wiring on the cathode side of the photodiode 17 does not intersect with the address wirings (G(n), G(n+1)). This makes it possible to suppress unwanted noise from the address signal to the photodiode 17, thereby improving sensor sensitivity.

Further, it is preferable that each of the pixels be constituted by a plurality of sub pixels for displaying such colors as red, green, and blue, the number of photoelectric elements arranged per pixel be smaller than the number of types of the plurality of sub pixels, and the photoelectric elements being contained in each photoelectric element group and effective for extracting sensing data be arranged in such a manner that photoelectric elements associated with pixels adjacent to each other across the common wiring (Vrst(n)) are associated with sub pixels differently in terms of the colors of the sub pixels.

According to the configuration above, each of the pixels is constituted by a plurality of sub pixels for displaying such colors as red, green, and blue, the number of photoelectric elements arranged per pixel is smaller than the number of types of the plurality of sub pixels, and the photoelectric elements being contained in each photoelectric element group and effective for extracting sensing data are arranged in such a manner that photoelectric elements associated with pixels adjacent to each other across the common wiring (Vrst(n)) are associated with sub pixels differently in terms of the colors of the sub pixels. This arrangement makes it possible to shorten the maximum interval between the photoelectric elements. This makes it possible to suppress deterioration in sensor accuracy in the two-dimensional sensor array.

Further, it is preferable that each of the pixels be constituted by a plurality of sub pixels for displaying such colors as red, green, and blue, the number of photoelectric elements arranged per pixel be smaller than the number of types of the plurality of sub pixels, and the photoelectric elements being contained in each photoelectric element group and effective for extracting sensing data be arranged in such a manner that photoelectric element groups electrically connected to the common wiring (Vrst(n)) commonly are associated with sub pixels differently in terms of the colors of the sub pixels.

According to the configuration above, each of the pixels is constituted by a plurality of sub pixels for displaying such colors as red, green, and blue, the number of photoelectric elements arranged per pixel is smaller than the number of types of the plurality of sub pixels, and the photoelectric elements being contained in each photoelectric element group and effective for extracting sensing data are arranged in such a manner that photoelectric element groups electrically connected to the common wiring (Vrst(n)) commonly are associated with sub pixels differently in terms of the colors of the sub pixels. This arrangement makes it possible to shorten the maximum interval between the photoelectric elements. This makes it possible to suppress deterioration in sensor accuracy in the two-dimensional sensor array.

The above-described display device is applicable to any electronics device in which a touch panel is mounted.

### Advantageous Effects of Invention

As described above, the two-dimensional sensor array according to the present invention includes: a plurality of photoelectric elements being two-dimensionally arranged and each outputting a signal with a value according to the quantity of light received by the photoelectric element, the plurality of photoelectric elements forming photoelectric element groups in each of which photoelectric elements arranged along a one-dimensional direction are grouped; and wirings, each of which is connected to the anode electrodes of the photoelectric elements in the corresponding one of the photoelectric element groups commonly, and is shared by at least two of the photoelectric element groups. This configuration makes it possible to increase the aperture ratio of the pixel compared to a case where the wiring connected commonly to the anode electrodes of the photoelectric elements in one photoelectric element group, in which photoelectric elements arranged along a one-dimensional direction are grouped, is not shared.

### BRIEF DESCRIPTION OF DRAWINGS

FIG. 1 is a view of the relation between a photoelectric element group and a resetting wiring in a two-dimensional sensor array, wherein (a) is a schematic view of a two-dimensional sensor array according to the present invention, and (b) is a schematic view of a two-dimensional sensor array of a comparative example.

FIG. 2 is a block diagram of a configuration of main sections of a liquid crystal display device.

FIG. 3 is an equivalent circuit diagram of an equivalent circuit for one pixel in the liquid crystal display device as shown in FIG. 2.

FIG. 4 is an equivalent circuit diagram of an equivalent circuit of a comparative example for the equivalent circuit schematic as shown in FIG. 3.

FIG. 5 is a timing diagram corresponding to the equivalent circuit as shown in FIG. 3.

FIG. 6 is a timing diagram corresponding to the equivalent circuit of the comparative example as shown in FIG. 4.

FIGS. 7(a) and 7(b) are views each showing the positional relation between a photosensor and a wiring for driving a pixel in a two-dimensional sensor array.

FIG. 8 is an equivalent circuit diagram of another example of an equivalent circuit for one pixel in the liquid crystal display device as shown in FIG. 2.

FIGS. 9(a) to 9(c) are views for describing intervals at which photodiodes are arranged in a two-dimensional sensor array.

FIGS. 10(a) to 10(c) are views for describing intervals at which photodiodes are arranged in a two-dimensional sensor array.

FIG. 11 is a view of an example in which the present invention is employed in another circuit.

FIG. 12 is a view of an example in which the present invention is employed in yet another circuit.

FIG. 13 is an equivalent circuit diagram of a conventional two-dimensional sensor array.

FIG. 14 is a timing diagram of the two-dimensional sensor array as illustrated in FIG. 13.

FIG. 15 is an equivalent circuit diagram of another conventional two-dimensional sensor array.

### DESCRIPTION OF EMBODIMENTS

One embodiment of the present invention will be described below. This embodiment is explained, referring to an example in which a display device according to the present invention is employed in a liquid crystal display device incorporating an optical sensor touch panel therein (hereinafter referred to as an optical sensor TP system).

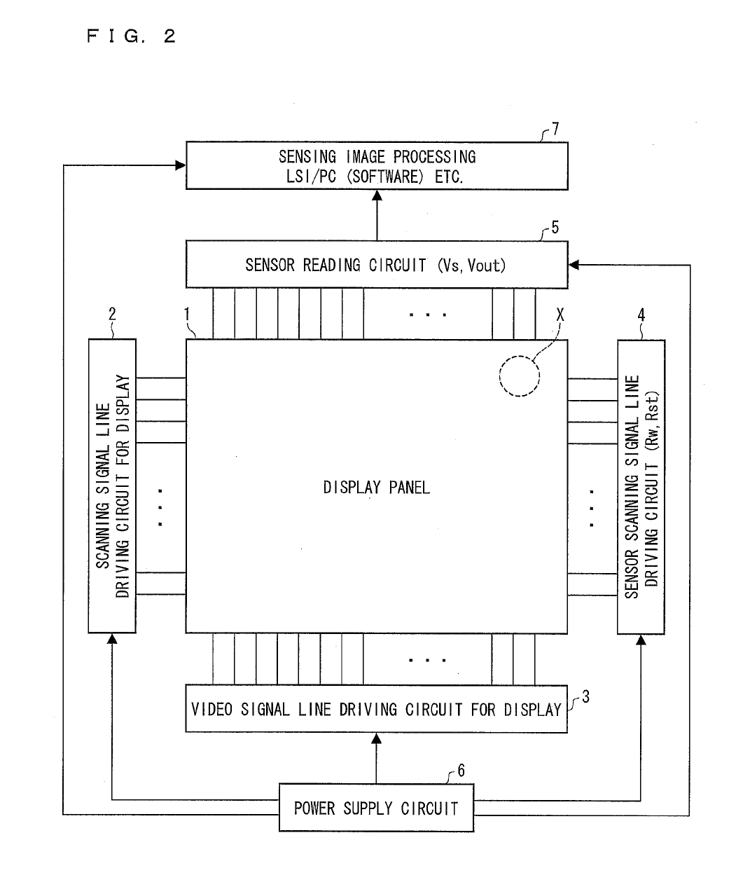

As illustrated in FIG. 2, the optical sensor TP system according to the present embodiment includes a display panel 1 including a photoelectric element serving as an optical sensor, and also includes, in a manner surrounding the display panel 1, a scanning signal line driving circuit 2 for display and a video signal line driving circuit 3 for display, which are circuits for causing the display panel 1 to display, a sensor scanning signal line driving circuit 4 and a sensor reading circuit 5, which are circuits for causing the display panel 1 to function as a touch panel, a sensing image processing LSI 7 (PC (including software)) for determining touched coordinates based on sensing data from the sensor reading circuit 5, and a power supply circuit 6.

Here, it should be noted that the liquid crystal display device as illustrated in FIG. 2 is merely an illustrative example and the present invention is not limited to this configuration. As one alternative, the present invention may employ a configuration in which the sensor scanning signal line driving circuit 4 and the sensor reading circuit 5 are included, as functions, in other circuits, specifically, in the scanning signal line driving circuit 2 for display, the video signal line driving circuit 3 for display, or the like, or a configuration in which the sensor reading circuit 5 is included in the function of the sensing image processing LSI 7.

The display panel 1 has, on the same substrate, a pixel array for implementing a display function of displaying images and a two-dimensional sensor array for implementing a sensor function of sensing a change in quantity of received light at such a position as where the user touches.

Here, the display panel 1 may be a liquid crystal display panel or an organic EL panel.

The pixel array is an array constituted by a plurality of pixels arranged in matrix. The two-dimensional sensor array is an array in which a display pixel incorporates an optical sensor therein.

The photoelectric element will be hereinafter described as an optical sensor (photodiode 17).

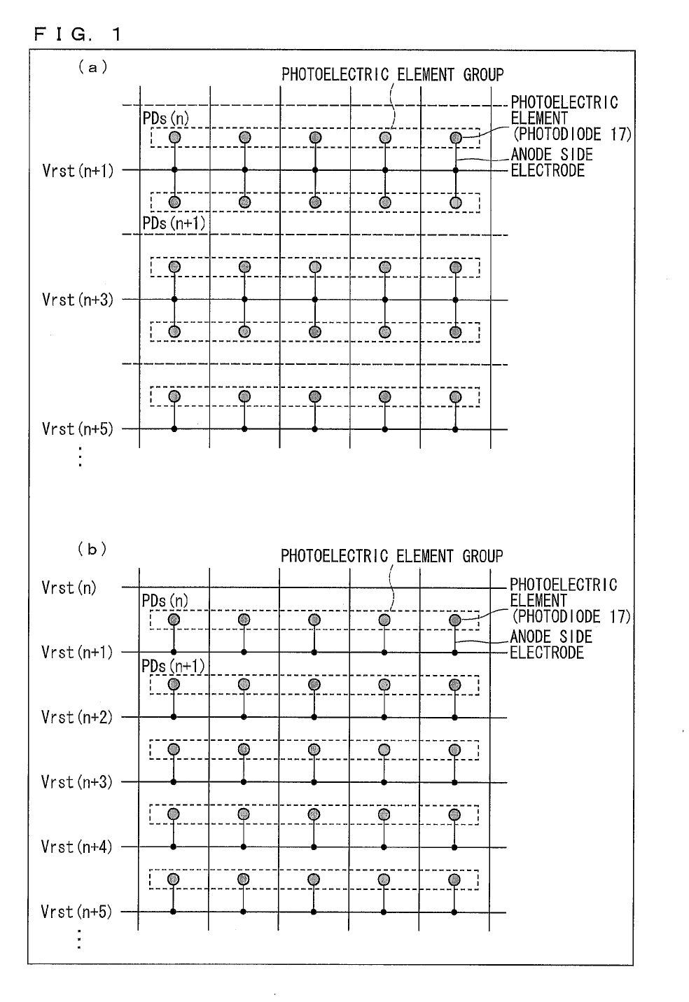

FIGS. 1(a) and 1(b) each illustrates the two-dimensional sensor array part of the display panel 1.

In the two-dimensional sensor array as illustrated in FIG. 1(a), a resetting wiring (Vrst (n+1): (n is an integer equal to or greater than 1)) for supplying a reset signal for resetting a photoelectric element is provided between a photoelectric element group (PDs(n)), which is formed from photoelectric elements arranged in the n-th row (n is an integer equal to or greater than 1), and a photoelectric element group (PDs(n+1)) adjacent to the photoelectric element group (PDs(n)).

The anode electrodes of the photoelectric elements in the photoelectric element group (PDs(n)) are connected commonly to the resetting wiring (Vrst(n+1)), and the anode electrodes of the photoelectric elements in the photoelectric element group (PDs(n+1)) are connected commonly to the resetting wiring (Vrst(n+1)).

That is, in the two-dimensional sensor array as illustrated in FIG. 1(a), photoelectric element groups adjacent to each other share the resetting wiring (Vrst).

On the other hand, in the two-dimensional sensor array as illustrated in FIG. 1(b), the resetting wiring (Vrst) is formed independently for the photoelectric element group in each row, and therefore the resetting wiring (Vrst) is not shared by photoelectric element groups adjacent to each other.

Therefore, according to the configuration as illustrated in FIG. 1(a), since the resetting wiring (Vrst), which is connected to the anode electrodes of the photoelectric elements in one photoelectric element group commonly, is shared by two photoelectric element groups, the number of the resetting wirings (Vrst) can be reduced by half compared to the case in which the resetting wiring (Vrst) is not shared by the photoelectric element groups as illustrated in FIG. 1(b).

The reduction makes it possible to simplify the circuit configuration of the two-dimensional sensor array.

For example, in a case where this two-dimensional sensor array is used in a display device and the above-described photoelectric element is provided in each pixel, it is possible to reduce the number of wirings at least by half compared to a case where the wiring is not shared by the photoelectric element groups. The reduction makes it possible to avoid a decrease in the aperture ratio of the pixel, the decrease resulting from providing the photoelectric element. That is, the reduction makes it possible to increase the aperture ratio of the pixel compared to the case where the wiring connected commonly to the anode electrodes of the photoelectric elements in one photoelectric element group, in which photoelectric elements arranged along a one-dimensional direction are grouped, is not shared as described above.

A description will be given below on the relation between the two-dimensional sensor arrays as schematically illustrated in FIGS. 1(a) and 1(b) and the pixel array in terms of connection and arrangement.

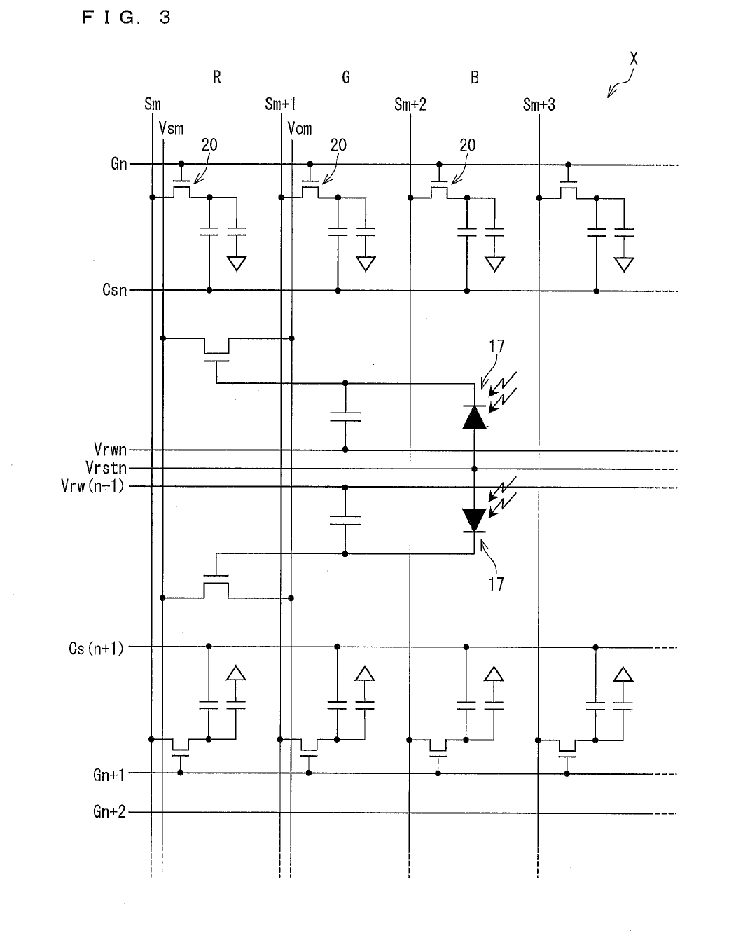

FIG. 3 is a one-pixel equivalent circuit of an enlarged part of the display panel 1 as illustrated in FIG. 2, and illustrates two pixels, top and bottom, in the case where the resetting wiring is shared by the photoelectric element groups adjacent to each other as illustrated in FIG. 1(a).

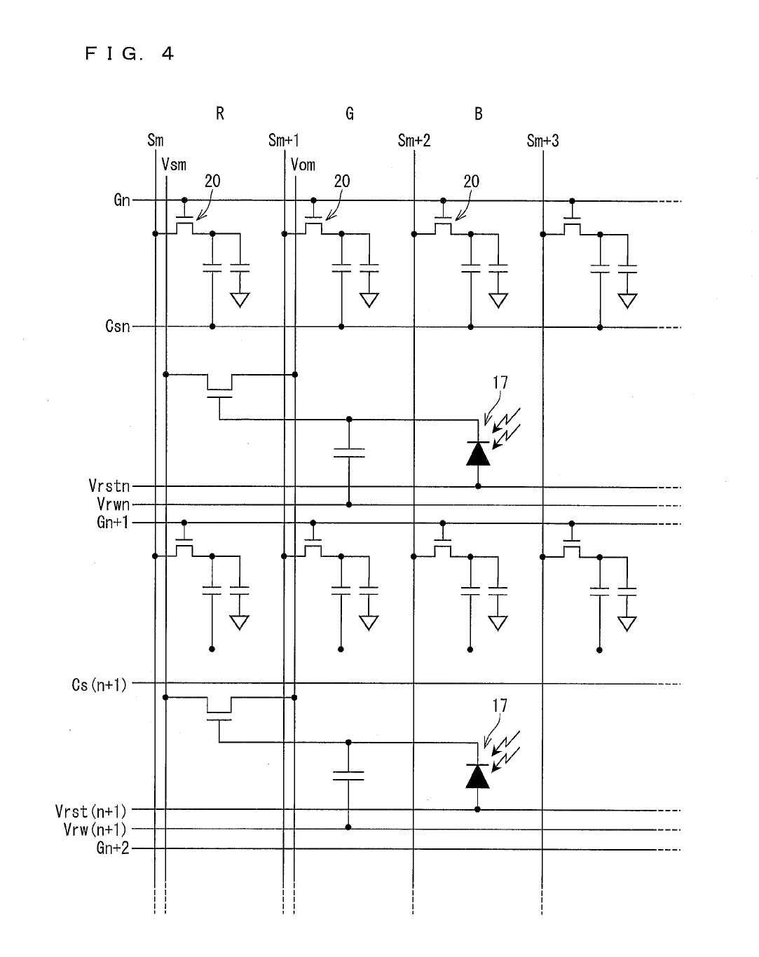

FIG. 4 is a view of two pixels, top and bottom, in the case where the resetting wiring is not shared by the photoelectric element groups adjacent to each other as illustrated in FIG. 1(b).

Here, the display panel 1 is exemplified as an active matrix type liquid crystal display panel, in which pixels are arranged in matrix and each of the pixels is driven independently. In FIGS. 3 and 4, ‘n,’ ‘n+1,’ ‘m,’ and ‘m+1’ written at the ends of the names of the wirings indicate ‘n-th row,’ ‘(n+1)-th row,’ ‘m-th row,’ and ‘(m+1)-th row,’ respectively.

Thus, as illustrated in FIG. 3, in one pixel X in the display panel 1, a gate wiring (Gn), a source wiring (Sm), and a storage capacitor wiring (Csn) are provided to serve as address wirings for display, and a resetting wiring (Vrstn) for resetting a photodiode 17, a NetA voltage-boosting capacitor driving wiring (Vrwn), a wiring (Vsm) for supplying voltage to an output AMP, and an optical sensor output wiring (Vom) are provided to serve as wirings for a detection circuit.

The gate wiring (Gn) is a wiring for supplying, to the display driving TFT element 20, a scanning signal outputted from the scanning signal line driving circuit 2 for display. The source wiring (Sm) is a wiring for supplying, to the display driving TFT element 20, a video signal outputted from the video signal line driving circuit 3 for display, the source wiring (Sm) being arranged in a manner orthogonally intersecting the gate wiring (Gn).

The storage capacitor wiring (Csn) is arranged parallel to the gate wiring (Gn) and connected to a storage capacitor (Cs) formed for the display driving TFT element 20.

The resetting wiring (Vrstn) for resetting the photodiode 17 is arranged parallel to the gate wiring (Gn) and connected to the anode side of the photodiode 17. The resetting wiring (Vrstn) supplies a reset signal outputted from the sensor scanning signal line driving circuit 4.

The NetA voltage-boosting capacitor wiring (Vrwn) is arranged parallel to the gate wiring (Gn) and connected to an electrode of a NetA voltage-boosting capacitor formed parallel to the photodiode 17, the electrode being on the opposite side to a node NetA on the cathode side of the photodiode 17.

The wiring (Vsm) for supplying voltage to the output AMP is arranged parallel to the source wiring (Sm) and connected to the source electrode of the output AMP.

The optical sensor output wiring (Vom) is arranged parallel to the source wiring (Sm) and connected to the drain electrode of the output AMP.

The optical sensor output wiring (Vom) is a wiring for inputting, to the sensor reading circuit 5, an output signal outputted from the output AMP. The output signal changes according to the quantity of light received by the photodiode 17.

As described above, the resetting wiring (Vrstn) is shared by two photodiodes 17 vertically adjacent to each other in the two-dimensional sensor array as illustrated in FIG. 3. That is, the resetting wiring (Vrstn) is shared by the photodiode 17 on the first line and the photodiode 17 on the second line, the resetting wiring (Vrstn) is shared by the photodiode 17 on the third line and the photodiode 17 on the fourth line, . . . , and the resetting wiring (Vrstn) is shared by the photodiode 17 on the n-th line and the photodiode 17 on the (n+1)-th line.

On the other hand, in the two dimensional sensor array as illustrated in FIG. 4, the resetting wiring (Vrstn) is independently provided for each individual photodiode 17 arranged along a one-dimensional direction, unlike in the two-dimensional sensor array as illustrated in FIG. 3.

Thus, in the two-dimensional sensor array as illustrated in FIG. 3, it is possible to reduce the number of the resetting wirings (Vrstn) by half compared to the two-dimensional sensor array as illustrated in FIG. 4. Due to the reduction, the area having been used in the pixel by the resetting wiring (Vrstn) to be shared becomes an aperture area. This makes it possible to increase the aperture ratio of the pixel.

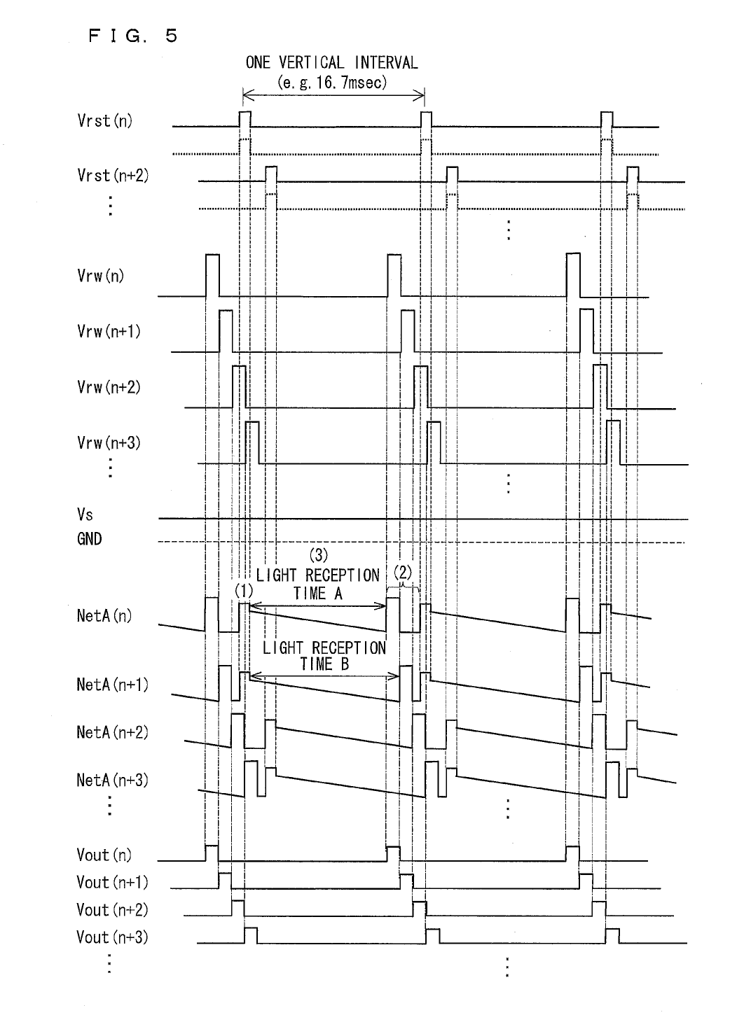

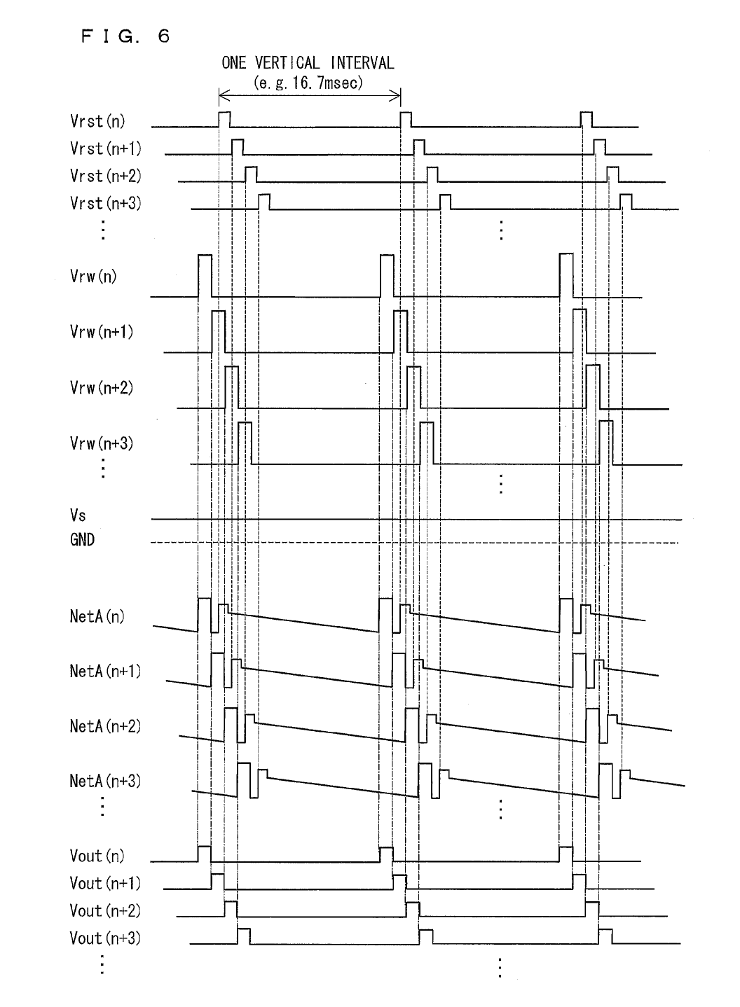

Timings of reading the photodiodes 17 in the configurations as illustrated in FIGS. 3 and 4 are respectively shown in the timing diagrams in FIGS. 5 and 6.

FIG. 5 is a timing diagram showing timings of reading the photodiodes 17 in the configuration as illustrated in FIG. 3.

FIG. 6 is a timing diagram showing timings of reading the photodiodes 17 in the configuration as illustrated in FIG. 4.

The timing diagrams in FIGS. 5 and 6 were each obtained when the pixel was driven with the element size and driving conditions as described below.

<Element Size>

L/W of the photodiode 17: 4/50 μm

capacitance of the capacitor for Net-boosting: 0.25 pf

L/W of the output AMP: 4/60 μm

<Driving Conditions>

Vrstn: −16 V->−4 V (High width 20 μsec)

Vrwm: −16 V->+24 V (High width 20 μsec)

Vsm: DC+15V

total light reception time:
n-th line: 15.980 msec
(n+1)-th line: 16.000 msec

<Others>

temperature: 27° C.

illuminance: 70 LX

In the case where the photodiodes 17 (on the n-th line) and the photodiodes 17 (on the (n+1)-th line) vertically adjacent to each other do not share the resetting wiring (Vrstn) and are independently provided with the resetting wiring (Vrstn) as illustrated in FIG. 4, there arises no problem in particular, since the timing at which the reset of each photodiode is completed sequentially shifts through time as indicated by the timing diagram in FIG. 6.

On the other hand, in the case where the resetting wiring (Vrstn) is shared by the photodiodes 17 (on the n-th line and the (n+1)-th line) vertically adjacent to each other as illustrated in FIG. 3, the timing at which the reset of the photodiode 17 (on the n-th line) is completed and the timing at which the reset of the photodiode 17 (on the (n+1)-th line) is completed are synchronized with each other, as indicated by the timing diagram in FIG. 5.

Here, since the reading of the upper wiring and the reading of the lower wiring cannot be simultaneously carried out, it is necessary to read either one (the n-th line in FIG. 5) of the upper and lower wirings before reading the other. As a result, the time (light reception time A) during which the photodiode 17 connected on the n-th line receives light is different in length from the time (light reception time B) during which the photodiode 17 connected on the (n+1)-th line receives light. This may cause a potential difference at NetA's and a difference in Vout output even under the same illuminance environment.

However, the difference in light reception time, specifically, a few μsec, is minor (light reception difference<1%) relative to the total light reception time (16 msec in a case of driving at 60 Hz). Therefore, it is unlikely that the difference in Vout output caused by the difference in light reception time will cause a problem during actual use.

In the actual experiment under the following conditions, a difference between a voltage at a NetA on the n-th line and a voltage at a NetA on the (n+1)-th line was about 30 mV, and a difference between a Vout on the n-th line and a Vout on the (n+1)-th line was on an unobservable level.

Here, a description will be given on how the relationship between the photodiode 17 and the wirings affects sensor sensitivity.

Here, regarding the following description on a position at which the photodiode 17 is arranged or the like, it should be noted that the photodiode 17 will be described with an attention paid to an element effective for extracting sensing data. Therefore, it will be understood that, in the present invention, photoelectric elements for ‘temperature compensation,’ ‘dark current compensation,’ or the like to be are arranged besides the photoelectric element for extracting sensing data may be included but will not be particularly given any consideration as to positions at which such photoelectric elements are arranged or the like.

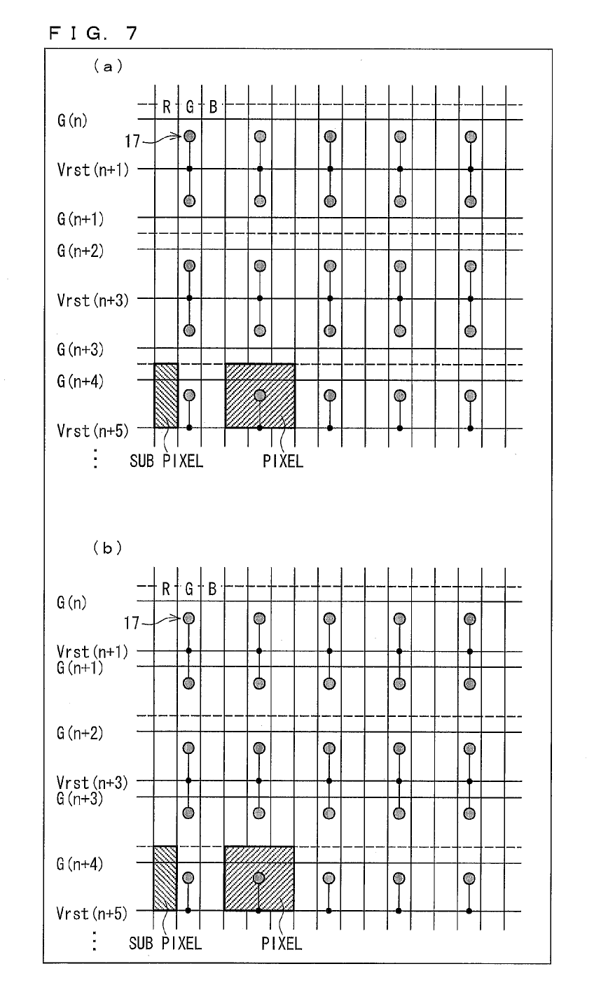

FIGS. 7(a) and 7(b) are schematic views each showing the positional relation between the address wiring G(n), which is connected to the pixels commonly, and the photodiode 17, in a case where one pixel is constituted by three sub pixels of colors red (R), green (G), and blue (B).

In both configurations as shown in FIGS. 7(a) and 7(b), the resetting wiring Vrst is shared. In the configuration in FIG. 7(b), however, the address wiring (G(n+1)), which is connected to the pixels commonly, is arranged in a manner intersecting with the anode of that one of the photodiodes 17 which is connected to the resetting wiring (Vrst(n+1)) on the address wiring (G(n+1)) side. This configuration increases the possibility that an address signal supplied to the address wiring (G(n+1)) acts as noise to the photodiode 17.

On the other hand, in FIG. 7(a), the address wiring (G(n+1)), which is connected to the pixels commonly, is arranged in a manner intersecting the anode of none of the photodiodes 17 in the photoelectric element groups on both sides of the address wiring (G(n+1)). This configuration makes it possible to suppress generation of noise to the photodiode 17, which noise is generated when an address signal is supplied to the address wiring (G(n+1)).

That is, as illustrated in FIG. 7(a), a display device includes: a plurality of pixels arranged in matrix; and photoelectric elements being provided in each of the pixels and each outputting a signal with a value according to the quantity of light received by the photoelectric element, the photoelectric elements being arranged such that: when photoelectric elements being arranged in the n-th row (n is an integer equal to or greater than 1) form a photoelectric element group (PDs(n)), (a) the anode electrodes of photoelectric elements in a photoelectric element group (PDs(n+1)) adjacent to the photoelectric element group (PDs(n)) and (b) the anode electrodes of photoelectric elements in the photoelectric element group (PDs(n)) are commonly connected to a common wiring (Vrst(n): (n is an integer equal to or greater than 1)), and the common wiring (Vrst(n)) is formed between an address wiring (G(n): (n is an integer equal to or greater than 1)), which is connected commonly to pixels with which the photoelectric element group (PDs(n)) is associated, and an address wiring (G(n+1)), which is connected commonly to pixels with which the photoelectric element group (PDs(n+1)) is associated. This configuration will suppress unwanted noise to the photodiode 17, thereby improving sensor sensitivity.

A description has been given, with reference to FIG. 7(a), on an example in which the photodiodes 17 in the upper photoelectric element group are formed on sub pixels of the same color (green (G)) as that of sub pixels on which the photodiodes 17 in the lower photoelectric element group are formed, the upper and lower photoelectric element groups sharing the resetting wiring (Vrst). However, it should be noted that the present invention is not limited to this example but may employ such a configuration that the photodiodes 17 are formed on sub pixels of different colors.

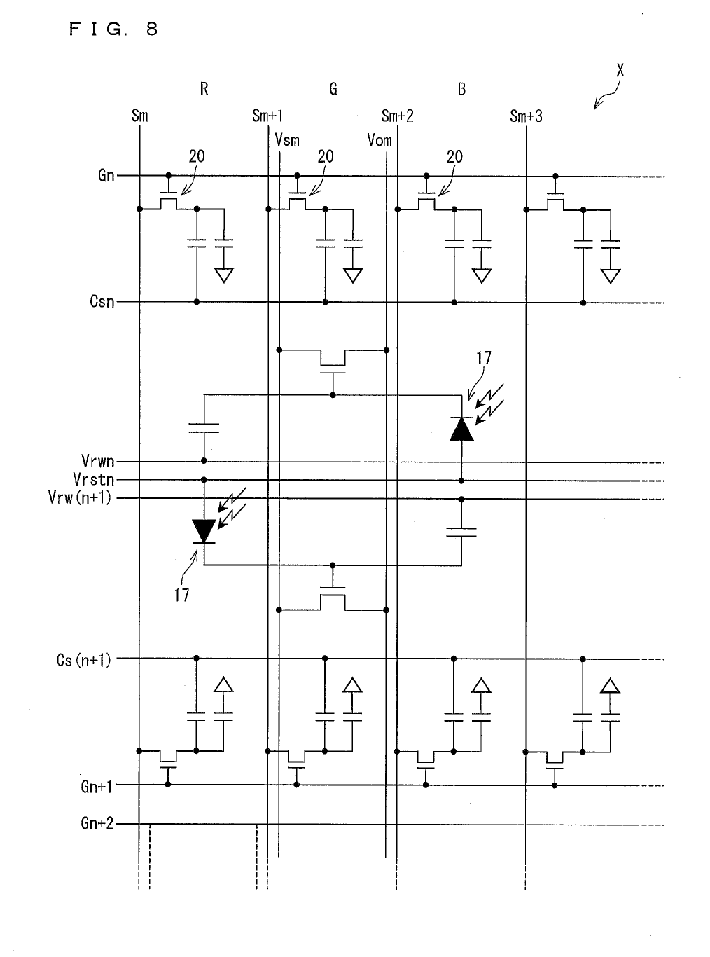

FIG. 8 illustrates an example in which the photodiodes 17 in the photoelectric element group above the resetting wiring (Vrst) are formed on sub pixels of a color (red (R)) different from the color (blue (B)) of sub pixels on which the photodiodes 17 in the photoelectric element group below the resetting wiring (Vrst) are formed, the photoelectric element groups above and below the resetting wiring (Vrst) sharing the resetting wiring (Vrst). In this case, the maximum distance between photodiodes 17 adjacent to each other is short compared to the case where the photodiodes 17 above the resetting wiring (Vrst) are formed on sub pixels of the same color as that of sub pixels on which the photodiodes 17 below the resetting wiring (Vrst) are formed as illustrated in FIG. 7(a). This allows the two-dimensional sensor array to have an improved sensing accuracy.

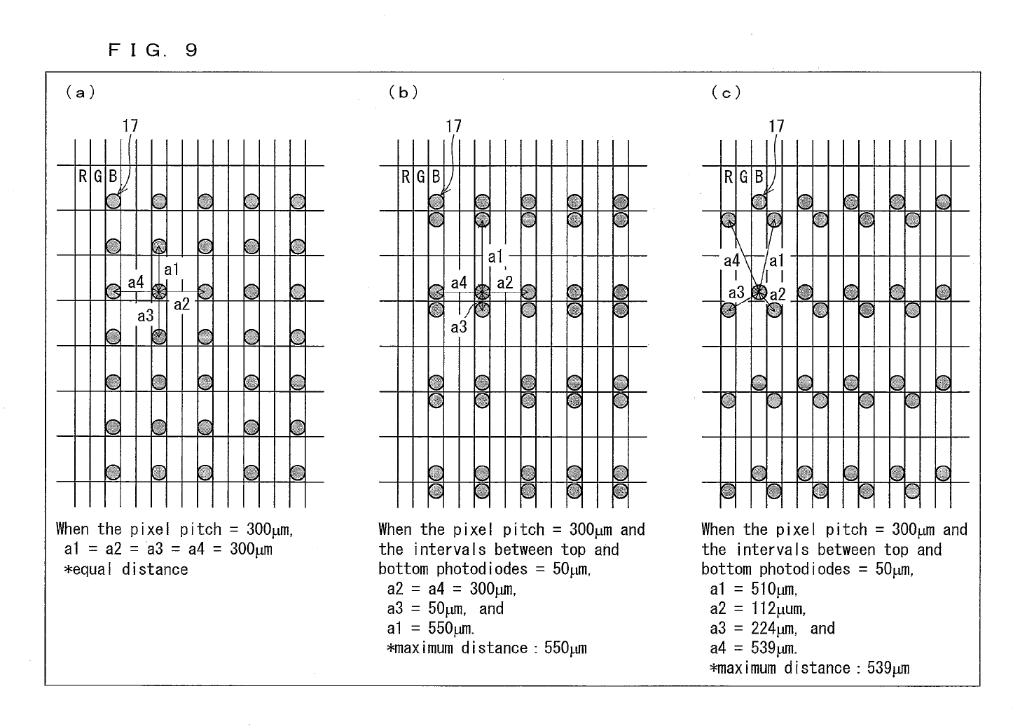

Here, intervals at which the photodiodes 17 are arranged will be described below with reference to FIGS. 9(a) to 9(c).

FIG. 9(a) is a view (corresponding to FIG. 5) for describing an average of intervals between the photodiodes 17 in a case where the resetting wiring (Vrst) is not shared by the photoelectric element groups above and below the resetting wiring (Vrst).

As illustrated in FIG. 9(a), the photodiodes 17 are all formed on sub pixels of blue color (B). Because of this, when an attention is paid to a certain photodiode 17, the distances a1, a1, a3, and a4 from the certain photodiode 17 to the four adjacent photodiodes 17 around the certain photodiodes 17 are equal to each other. In this case, when the pitch between the sub pixels is 300 μm, a1=a2=a3=a4=300 μm.

FIG. 9(b) is a view (corresponding to FIG. 6) showing an example for describing an average of intervals between photodiodes 17 in a case where the resetting wiring (Vrst) is shared by the photoelectric element groups above and below the resetting wiring (Vrst).

As illustrated in FIG. 9(b), the photodiodes 17 are all formed on sub pixels of blue color (B). Because of this, when an attention is paid to a certain photodiode 17, the distances a1, a2, a3, and a4 from the certain photodiode 17 to the four adjacent photodiodes 17 around the certain photodiode 17 have the following values. That is, when the pitch between the sub pixels=300 μm, a1=550 μm, a2=a4=300 μm, and a3=50 μm. In this case, the maximum interval between the photodiodes 17 is 550 μm.

FIG. 9 (c) is a view (corresponding to FIG. 8) for showing another example for describing an average of intervals between the photodiodes 17 in a case where the resetting wiring (Vrst) is shared by the photoelectric element groups above and below the resetting wiring (Vrst).

As illustrated in FIG. 9(c), the photodiodes 17 in the photoelectric element group above the resetting wiring (Vrst) are formed on a color (blue (B)) different from the color (red (R)) on which the photodiodes 17 in the photoelectric element group below the resetting wiring (Vrst) are formed. When an attention is paid to a certain photodiode 17, the distances a1, a2, a3, and a4 from the certain photodiode 17 to the four adjacent photodiodes 17 around the certain photodiode 17 will have the following values. That is, when the pitch between the sub pixels=300 μm, a1=510 μm, a2=112 μm, a3=224 μm, and a4=539 μm. In this case, the maximum interval between the photodiodes 17 is 539 μm.

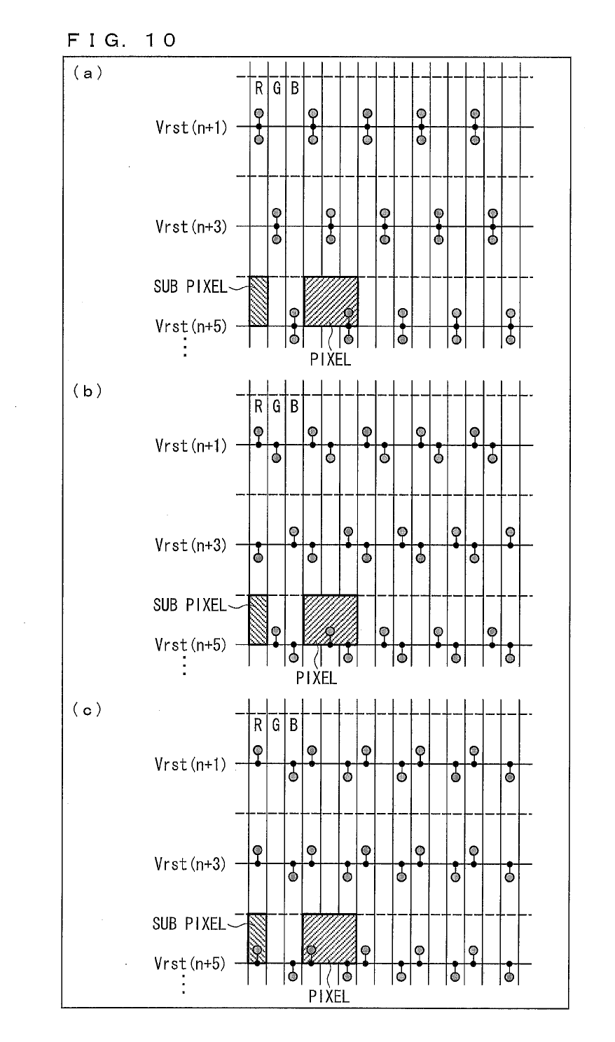

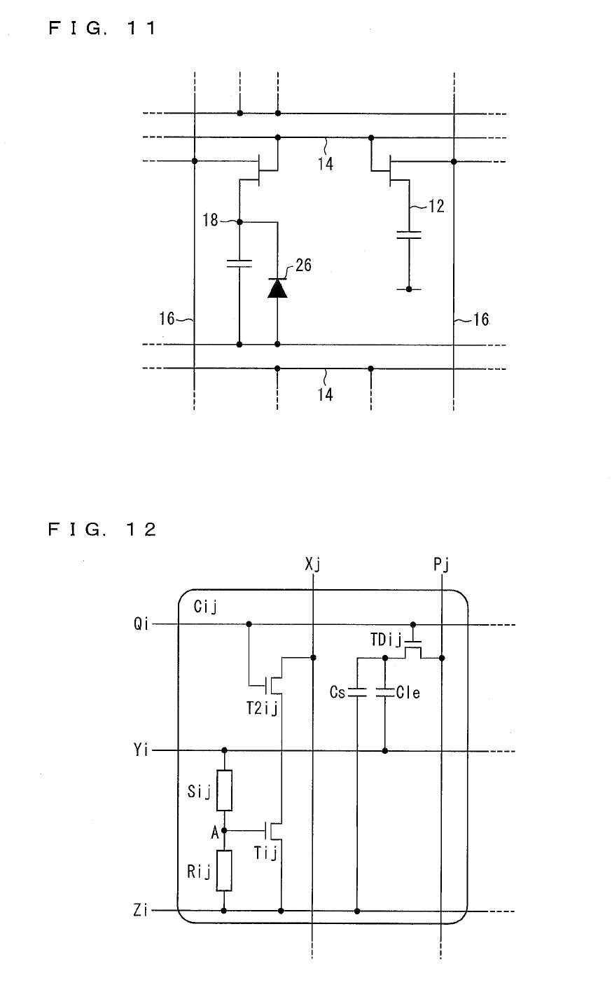

Further, it should be noted that the configuration of the pixels in which the photodiodes 17 are arranged according to the present invention is not limited to the configuration as illustrated in FIG. 9(c). Other configurations, for example, ones as illustrated in FIGS. 10(a) to 10(c), may be employed in the present invention.

In FIG. 10(a), the photodiodes 17 connected to the resetting wiring (Vrst(n+1)) from above and below thereof are formed on sub pixels of the same color (red (R)). However, although the photodiodes 17 connected to the adjacent resetting wiring (Vrst(n+3)) from above and below thereof are formed on sub pixels of the same color, this color (green (G)) is different from the color of the sub pixels on which the photodiodes 17 connected to the resetting wiring (Vrst(n+1)) are formed.

In FIG. 10(b), the photodiodes 17 connected to the resetting wiring (Vrst(n+1)) from above thereof are formed on sub pixels of a color different from the color of sub pixels on which the photodiodes 17 connected to the resetting wiring (Vrst(n+1)) from below thereof are formed, and the photodiodes 17 connected to the resetting wiring (Vrst(n+3)) from above thereof are formed on sub pixels of a color different from the color of sub pixels on which the photodiodes 17 connected to the resetting wiring (Vrst(n+3)) from below thereof are formed.

In FIG. 10(c), the photodiodes 17 connected to the resetting wiring (Vrst(n+1)) from above thereof are formed on sub pixels of a color different from the color of sub pixels on which the photodiodes 17 connected to the resetting wiring (Vrst(n+1)) from below thereof are formed, and this pattern is repeated.

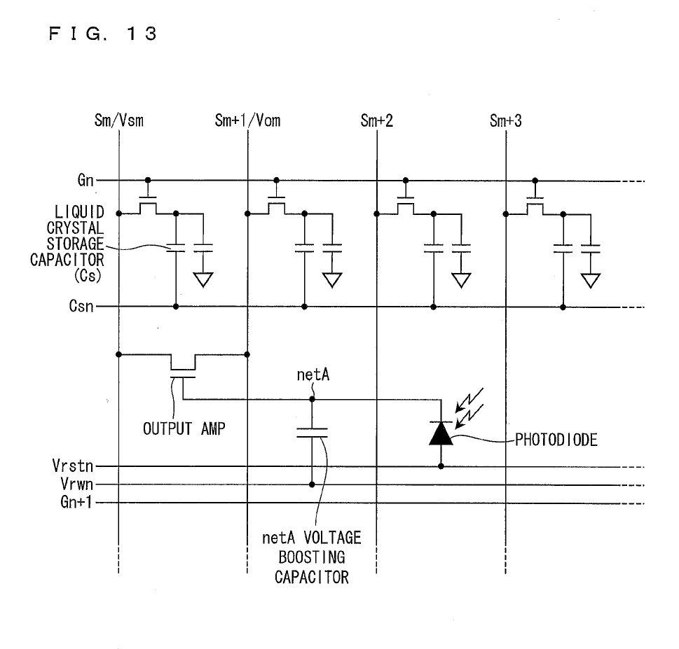

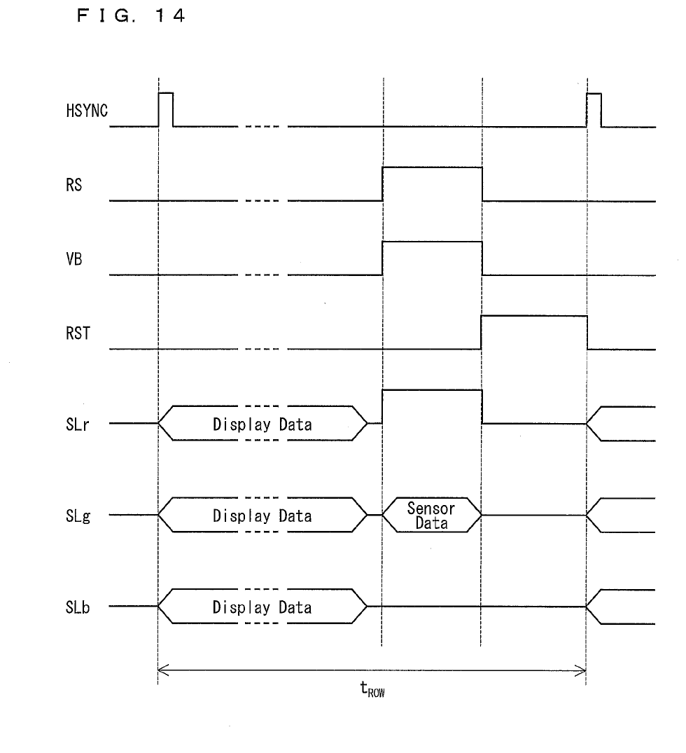

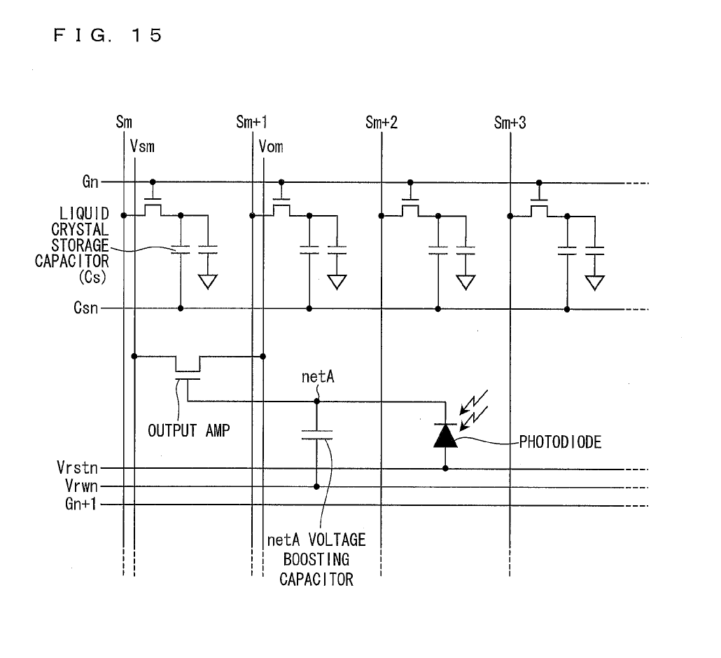

As described above, a feature of the present invention resides in the two-dimensional sensor array employing the photodiode 17. Therefore, the present invention is not limited to the circuit configurations as illustrated in FIGS. 3, 4, and 8, and is applicable to other circuit configurations, namely, to a wiring electrically connected to the anode side of an optical sensor element. For example, the present invention is also applicable to circuit configurations as illustrated in FIGS. 11 and 12.

Further, in the present embodiment, a description has been given on the example in which both a pixel in which the photoelectric element (photodiode 17) is provided and a pixel on which no photoelectric element (photodiode 17) is provided exist, assuming a case of a display device (LCD for a small portable device or the like) in which a two-dimensional sensor array is mounted and which is capable of displaying a high-definition image. However, it will be understood that the present invention is not limited to this example. As one alternative, the present invention may employ a configuration in which the photodiode 17 is provided in each individual pixel.

The present invention is not limited to the above-described embodiments but allows various modifications within the scope of the claims. In other words, any embodiment obtained by combining technical means appropriately modified within the scope of the claims will also be included in the technical scope of the present invention.

### INDUSTRIAL APPLICABILITY

This invention is readily applicable to an electronics device having a touch panel mounted therein.

### REFERENCE SIGNS LIST

1: DISPLAY PANEL
2: SCANNING SIGNAL LINE DRIVING CIRCUIT FOR DISPLAY
3: VIDEO SIGNAL LINE DRIVING CIRCUIT FOR DISPLAY
4: SENSOR SCANNING SIGNAL LINE DRIVING CIRCUIT
5: SENSOR READING CIRCUIT
6: POWER SUPPLY CIRCUIT
17: PHOTODIODE (PHOTOELECTRIC ELEMENT)
20: DISPLAY DRIVING TFT ELEMENT

1. A two-dimensional sensor array comprising:
a plurality of photoelectric elements being two-dimensionally arranged and each outputting a signal with a value according to a quantity of light received by the photoelectric element, the plurality of photoelectric elements forming photoelectric element groups in each of which photoelectric elements arranged along a one-dimensional direction are grouped; and
wirings, each of which is connected to anode electrodes of the photoelectric elements in the corresponding one of the photoelectric element groups commonly, and is shared by at least two of the photoelectric element groups.

2. The two-dimensional sensor array according to claim 1, wherein the plurality of photoelectric elements include photoelectric elements effective for extracting sensing data, wherein the photoelectric elements effective for extracting sensing data are arranged in such a manner that centers of light reception sections of adjacent ones of the photoelectric elements are distanced with a predetermined error range.

3. A display device comprising:
a plurality of pixels arranged in matrix;
photoelectric elements each outputting a signal with a value according to a quantity of light received by the photoelectric element, the photoelectric elements forming photoelectric element groups in each of which the photoelectric elements arranged along a one-dimensional direction are grouped; and
wirings, each of which is connected to anode electrodes of the photoelectric elements in the corresponding one of the photoelectric element groups commonly, and is shared by at least two of the photoelectric element groups.

4. The display device according to claim 3, wherein the photoelectric elements include photoelectric elements effective for extracting sensing data, wherein the photoelectric elements effective for extracting sensing data are arranged in such a manner that centers of light reception sections of adjacent ones of the photoelectric elements are distanced with a predetermined error range.

5. A display device comprising:
a plurality of pixels arranged in matrix; and
photoelectric elements each outputting a signal with a value according to a quantity of light received by the photoelectric element,
the photoelectric elements being arranged such that:
when photoelectric elements being arranged in an n-th row (n is an integer equal to or greater than 1) form a photoelectric element group (PDs(n)),
(a) anode electrodes of photoelectric elements in a photoelectric element group (PDs(n+1)) adjacent to the photoelectric element group (PDs(n)) and (b) anode electrodes of photoelectric elements in the photoelectric element group (PDs(n)) are commonly connected to a common wiring (Vrst(n): (n is an integer equal to or greater than 1)), and the common wiring (Vrst(n)) is formed between an address wiring (G(n): (n is an integer equal to or greater than 1)), which is connected commonly to pixels with which the photoelectric element group (PDs(n)) is associated, and an address wiring (G(n+1)), which is connected commonly to pixels with which the photoelectric element group (PDs(n+1)) is associated.

6. The display device according to claim 5, wherein each of the pixels is constituted by a plurality of sub pixels for displaying such colors as red, green, and blue, a number of photoelectric elements arranged per pixel is smaller than a number of types of the plurality of sub pixels, and the photoelectric elements being contained in each photoelectric element group and effective for extracting sensing data are arranged in such a manner that photoelectric elements associated with pixels adjacent to each other across the common wiring (Vrst(n)) are associated with sub pixels differently in terms of the colors of the sub pixels.

7. The display device according to claim 5, wherein each of the pixels is constituted by a plurality of sub pixels for displaying such colors as red, green, and blue, a number of photoelectric elements arranged per pixel is smaller than a number of types of the plurality of sub pixels, and the photoelectric elements being contained in each photoelectric element group and effective for extracting sensing data are arranged in such a manner that photoelectric element groups electrically connected to the common wiring (Vrst(n)) commonly are associated with sub pixels differently in terms of the colors of the sub pixels.

8. An electronics device comprising:
a two dimensional sensor array including a plurality of photoelectric elements being two-dimensionally arranged and each outputting a signal with a value according to a quantity of light received by the photoelectric element, the plurality of photoelectric elements forming photoelectric element groups in each of which photoelectric elements arranged along a one-dimensional direction are grouped; and
wirings, each of which is connected to anode electrodes of the photoelectric elements in the corresponding one of the photoelectric element groups commonly, and is shared by at least two of the photoelectric element groups.

9. An electronics device comprising:
a display device including:
a plurality of pixels arranged in matrix;
photoelectric elements each outputting a signal with a value according to a quantity of light received by the photoelectric element, the photoelectric elements forming photoelectric element groups in each of which the photoelectric elements arranged along a one-dimensional direction are grouped; and
wirings, each of which is connected to anode electrodes of the photoelectric elements in the corresponding one of the photoelectric element groups commonly, and is shared by at least two of the photoelectric element groups.

10. An electronics device comprising:
a display device including:
a plurality of pixels arranged in matrix; and
photoelectric elements each outputting a signal with a value according to a quantity of light received by the photoelectric element,
the photoelectric elements being arranged such that:
when photoelectric elements being arranged in an n-th row (n is an integer equal to or greater than 1) form a photoelectric element group (PDs(n)),
(a) anode electrodes of photoelectric elements in a photoelectric element group (PDs(n+1)) adjacent to the photoelectric element group (PDs(n)) and (b) anode electrodes of photoelectric elements in the photoelectric element group (PDs(n)) are commonly connected to a common wiring (Vrst(n): (n is an integer equal to or greater than 1)), and the common wiring (Vrst(n)) is formed between an address wiring (G(n): (n is an integer equal to or greater than 1)), which is connected commonly to pixels with which the photoelectric element group (PDs(n)) is associated, and an address wiring (G(n+1)), which is connected commonly to pixels with which the photoelectric element group (PDs(n+1)) is associated.
